(19) United States
(12) Patent Application Publication
(10) Pub. No.: US 2019/0317658 A1
(43) Pub. Date: Oct. 17, 2019

(54) INTERACTION METHOD AND DEVICE FOR A FLEXIBLE DISPLAY SCREEN

(71) Applicant: SHENZHEN ROYOLE TECHNOLOGIES CO., LTD., Shenzhen (CN)

(72) Inventors: Xuan ZHANG, Shenzhen (CN); Xiangnan GU, Shenzhen (CN); Li ZHOU, Shenzhen (CN)

(21) Appl. No.: 16/451,903

(22) Filed: Jun. 25, 2019

Related U.S. Application Data
(63) Continuation of application No. PCT/CN2016/112128, filed on Dec. 26, 2016.

(51) Int. Cl. G06F 3/0481; G09G 5/14; G06F 3/0484

(52) U.S. Cl. CPC G06F 3/04817; G09G 5/14; G06F 3/0481; G09G 2340/145; G09G 2354/00; G09G 2380/02; G06F 2203/04804; G06F 3/04842

(57) ABSTRACT

An interaction method for a flexible display screen includes: in accordance with a determination that the flexible display screen is folded, switching a display area of the flexible display screen from a first display area to a second display area, the first display area corresponding to a first display window, and the second display area corresponding to a second display window; obtaining a control on the second display window with a property of invisibility as a target control, and obtaining a first parameter of the target control; and displaying prompt information containing the first parameter of the target control on the second display window. An interaction method for a flexible display screen is further provided by the present disclosure. Applying the present disclosure, an invisible control can be prompted on the display area, thus obtaining more operations for a user, and improving the user experience.

### CROSS-REFERENCE TO RELATED APPLICATION

This application is a continuation of PCT/CN2016/112128, filed on Dec. 26, 2016, the disclosure of which is hereby incorporated by reference in its entirety.

### TECHNICAL FIELD

The present disclosure relates to a technical field of a flexible display screen, more particularly to an interaction method and device for a flexible display screen.

### BACKGROUND

Currently, common interactive modes of electronic devices include touch and click interaction. With the rise of flexible display screens in recent years, it will bring possibilities of many new gestures, and gesture interactions may be more intuitive and easy to use. Most of the existing flexible display screens use flexible OLED technology, which has bendable, twistable and foldable characteristics, thus a high-resolution and large-sized area and the portability of the devices may be no longer paradox, durable programs may be also significantly higher than previous screens, and a probability of accidental damage of the device may be decreased.

Some foldable flexible devices can adapt to different occasions by a characteristic of variable sizes. For example, when a user goes out for commuting, a smart watch is set to be an ordinary watch, which brings a good portability; when the user needs to view more content, a surface of the smart watch can be stretched to form a large screen, such that it is convenient for the user to perform more complex operations. Such that a variable-sized device can simultaneously satisfy the user's demand for large screen and portability, and thus bring a better experience.

However, when the flexible devices are in a small screen interface state, only main functions of a current application can be displayed due to a small screen. When the flexible devices are in a large screen interface state, more detailed controls, such as functions and contents, can be displayed. Therefore, in the prior art, when the user operates on a small screen interface, the user can't know whether there are more controls on the same application interface in the large screen state, thus operable functions may be insufficient for the user, and the user experience may be decreased.

### SUMMARY

Based on this, in order to solve a technical problem in the prior art that, when a user operates on a small screen interface, the user can't know whether there are more controls on the same application interface in a large screen state, such that operable functions may be insufficient for the user, and the user experience may be decreased. An interaction method for a flexible display screen is provided.

An interaction method for a flexible display screen includes: in accordance with a determination that the flexible display screen is folded, switching a display area of the flexible display screen from a first display area to a second display area, the first display area corresponding to a first display window, and the second display area corresponding to a second display window; obtaining a control on the second display window with a property of invisibility as a target control, and obtaining a first parameter of the target control; and displaying prompt information containing the first parameter of the target control on the second display window.

In addition, in order to solve a technical problem in the prior art that, when a user operates on a small screen interface, the user can't know whether there are more controls on the same application interface on a large screen, such that operable functions may be insufficient for the user, and the user experience may be decreased. An interaction device for a flexible display screen is further provided.

An interaction device for a flexible display screen includes: a display area switch module configured to, in accordance with a determination that the flexible display screen is folded, switch a display area of the flexible display screen from a first display area to a second display area, where the first display area corresponds to a first display window, and the second display area corresponds to a second display window;
a target control obtaining module configured to obtain a control on the second display window with a property of invisibility as a target control, and obtaining a first parameter of the target control; and
a prompt information display module configured to display prompt information containing the first parameter of the target control on the second display window.

Implementation of some embodiments of the present disclosure will have the following beneficial effects.

In an embodiment of the present disclosure, the method includes: in accordance with a determination that the flexible display screen is folded, switching a display area of the flexible display screen from a first display area to a second display area, the first display area corresponding to a first display window, and the second display area corresponding to a second display window; obtaining a control on the second display window with a property of invisibility as a target control, and obtaining a first parameter of the target control; and displaying prompt information containing the first parameter of the target control on the second display window. When the first display area of the flexible display screen is too small to display control content fully, the invisible control can be prompted on the display area, thus providing more operations for the user, and improving the user experience.

In another embodiment, in order to solve a technical problem in the prior art that, when a user operates on a small screen interface, the user can't know whether there are more controls on the same application interface on a large screen, such that operable functions may be insufficient for the user, and the user experience may be decreased. An interaction method for a flexible display screen is further provided.

An interaction method for a flexible display screen includes: in accordance with a determination that the flexible display screen is folded, switching a display area of the flexible display screen from a first display area to a second display area, the first display area corresponding to a first display window, and the second display area corresponding to a second display window;
obtaining a first control set contained on the first display window and a second control set contained on the second display window;
obtaining a control which belongs to the first control set but not the second control set as the target control, and obtaining number of the target control(s); and
displaying prompt information containing the number of the target control(s) on the second display window.

Furthermore, in order to solve a technical problem in the prior art that, when a user operates on a small screen interface, the user can't know whether there are more controls on the same application interface in a large screen state, such that operable functions may be insufficient for the user, and the user experience may be decreased. An interaction device for a flexible display screen is further provided.

An interaction device for a flexible display screen includes:
a display area switch module configured to, in accordance with a determination that the flexible display screen is folded, switch a display area of the flexible display screen from a first display area to a second display area, where the first display area corresponds to a first display window, and the second display area corresponds to a second display window;
a control set obtaining module configured to obtain a first control set contained on the first display window and a second control set contained on the second display window;
a target control obtaining module configured to obtain a control which belongs to the first control set but not the second control set as the target control, and obtaining number of the target control(s); and
a prompt information display module configured to display prompt information containing the number of the target control(s) on the second display window.

Implementation of some embodiments of the present disclosure will have the following beneficial effects.

In an embodiment of the present disclosure, the method includes: in accordance with a determination that the flexible display screen is folded, switching a display area of the flexible display screen from a first display area to a second display area, the first display area corresponding to a first display window, and the second display area corresponding to a second display window; obtaining a first control set contained on the first display window and a second control set contained on the second display window; obtaining a control on the second display window with a property of invisibility as a target control, and obtaining a first parameter of the target control; and displaying prompt information containing the first parameter of the target control on the second display window. When the first display area of the flexible display screen is too small to display control content fully, the invisible control can be prompted on the display area, thus providing more operations for the user, and thereby improving the user experience.

### BRIEF DESCRIPTION OF THE DRAWINGS

In order to more clearly illustrate the technical solution of the present disclosure, the accompanying drawings required for describing the embodiments will be briefly described below. Apparently, the accompanying drawings in the following description are merely the embodiments of the present disclosure, and other drawings may be obtained by those skilled in the art according to these accompanying drawings without paying any creative labor.

FIG. 1 is a schematic view of an interface of a flexible display screen.

FIG. 2 is a flowchart of an interaction method for a flexible display screen provided by one embodiment.

FIG. 3 is a schematic view of a hierarchical level of a control of an interface of a flexible display screen provided by an embodiment.

FIG. 4 is a schematic view of a display window of a flexible display screen provided by a first embodiment.

FIG. 5 is a schematic view of a display window of a flexible display screen provided by a second embodiment.

FIG. 6 is a schematic view of a display window of a flexible display screen provided by a third embodiment.

FIG. 7 is a schematic view of a display window of a flexible display screen provided by a fourth embodiment.

FIG. 8 is a flowchart of an interaction method for a flexible display screen provided by another embodiment.

FIG. 9 is a schematic view of a display window of a flexible display screen provided by a fifth embodiment.

FIG. 10 is a schematic view of a display window of a flexible display screen provided by a sixth embodiment.

FIG. 11 is a flowchart of an interaction device for a flexible display screen provided by one embodiment.

FIG. 12 is a flowchart of an interaction device for a flexible display screen provided by another embodiment.

FIG. 13 is a hardware architecture diagram of a computer system for operating an interactive method of the above flexible display screen in an embodiment.

### DETAILED DESCRIPTION

The technical solutions in the embodiments of the present disclosure are clearly and completely described below with reference to the accompanying drawings in the embodiments of the present disclosure. Apparently, the described embodiments are merely some but not all of the embodiments of the present disclosure.

It should be understood that the terms used herein is for the purpose of describing particular embodiments only, and is not intended to limit the application. As used herein, the singular forms “a” and “the” are intended to include the plural forms as well, unless the context clearly indicates otherwise. It should also be understood that the terms “and/or” used herein refers to and includes any and all possible combinations of one or more of the associated listed items.

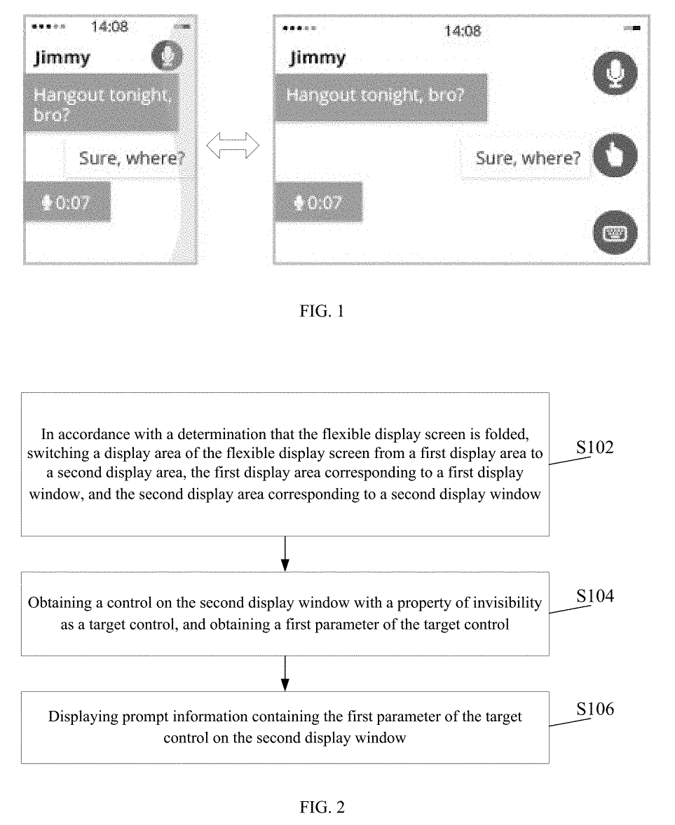

A flexible display screen is a transformable and bendable display device, which is made of a soft material. In the prior art, a flexible device can adapt to different occasions by a characteristic of variable sizes. However, as illustrated in FIG. 1, when the flexible device is in a small screen interface state, only main functions of a current application can be displayed due to the small screen. When the flexible device is in a large screen interface state, more detailed controls, such as functions and contents, can be displayed. Therefore, in the prior art, when the user operates on a small screen interface, the user can't know whether there are more controls on the same application interface in the large screen state, thus operable functions may be insufficient for the user, and the user experience may be decreased.

In order to solve a technical problem in the prior art that, when a user operates on a small screen interface, the user can't know whether there are more controls on the same application interface in a large screen state, such that operable functions may be insufficient for the user, and the user experience may be decreased. Two interaction methods for a flexible display screen are provided. An implementation of the two methods may rely on a computer program. The computer program may be a driver manager or a virtual device manager of the flexible display screen. The computer program can run on a computer system based on a von Neumann Computer system. The computer program can be a terminal device with the flexible display screen, such as a personal computer, a notebook computer, a tablet computer, and a smart phone.

### Embodiment 1

As illustrated in FIG. 2, FIG. 2 is a flowchart of an interaction method for a flexible display screen provided by an embodiment, and the method includes the following processes.

At block S102, in accordance with a determination that the flexible display screen is folded, a display area of the flexible display screen is switched from a first display area to a second display area. The first display area corresponds to a first display window, and the second display area corresponds to a second display window.

In this embodiment, in accordance with a determination that the flexible display screen is folded, the display area of the flexible display screen is switched from the first display area to the second display area. The first display area is a display area of the flexible display screen upon being unfolded, and the second display area is a display area of the flexible display screen upon being folded. A display window displayed on the first display area is defined as the first display window. A display window displayed on the second display area is defined as the second display window. Different contents can be displayed on the different display windows according to a size of the display area of the flexible display screen. For example, as illustrated in a right figure of FIG. 1, the display area displayed on the flexible display screen in an unfolded state is the first display area. As illustrated in a left figure of FIG. 1, the display area displayed on the flexible display screen in a folded state is the second display area. The user can switch the display area of the flexible display screen upon folding or unfolding the flexible display to change the size of the display area of the flexible display screen.

At block S104, a control on the second display window with a property of invisibility is obtained as a target control, and a first parameter of the target control is obtained.

In this embodiment, a control is a graphical user interface element, which is a basic visual building block. The control is contained in an application program, which is configured to control data processed by the application, and the interactive operation between the data and the user. The control includes a command control, such as a button, a selection control, such as a selection box, a drop-down menu, and a combination button, and an input control, such as a input box, a slider, and a search box, and a display control, such as a text box and a card. For example, when an interface window displayed by a current device is a music player, an interface control of the interface window includes, but is not limited to, a playlist control, a lyric display control, a song search control, and the like. When a song search function is selected, the interface control in the interface window can be a text box, a button, an information bar, and the like.

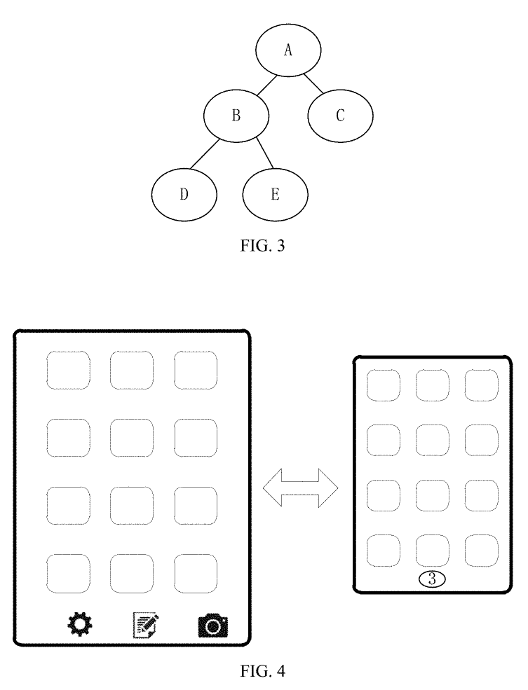

Each display window includes a plurality of controls. In an embodiment, a level can be adapted to describe a hierarchical level relationship of the controls in an interface. The smaller the level is, the higher the hierarchical level of the control in the interface corresponding to the level is. The larger the level is, the lower the hierarchical level of the control in the interface corresponding to the level is. Specifically, the hierarchical level of the control is illustrated by taking FIG. 3 as an example. It is assumed that an interface includes five controls A, B, C, D, and E. The relationship between the controls is the control A being a root control, the control B and the control C being a child control of the control A, and the control D and the control E being a child control of the control B. A level of the control A equals 1. A level of the control B and a level of the control C equal 2. A level of the control D and a level of the control E equal 3. It is determined that whether the current control is the root control by searching the hierarchical level of the control. In accordance with a determination that a root control is detected, the root control starts traversing and reading property information of all child controls.

Feature information of the target control, such as quantity, title, format, and position, is obtained as the first parameter. The properties of the control can be configured to describe various characteristics of each of the controls, such as the title, the format, visibility, and the position. In this embodiment, the visibility of the control can be directly read to determine whether the currently detected control is hidden. The visibility of the control includes three types: visible, invisible, and gone. The visible means that the control is visible. The invisible means that the control is invisible, but still takes up a memory space. The gone means that the control is invisible and does not take up the memory space. When searching visibility of a control is invisible, it is determined that the control is hidden, and the control is taken as a target control. In this embodiment, the feature information of the target control is taken as the first parameter of the target control. The first parameter is generated by doing statistical analysis of the feature information of the target control. For example, the first parameter is quantity feature information. The second display window includes a total of ten controls. Number of the controls with properties of invisibility is three. That is, a content of the prompt information of the first parameter is that the number of the target controls is three.

In this embodiment, before switching the display area of the flexible display screen from the first display area to the second display area, a relevant parameter of a control on the first display window is obtained. A control which needs to be hidden according to a relevant parameter of the control on the first display window is determined, and the property of the control is changed to be invisible, thus hiding the control on the second display window. The related parameter of the control includes at least one of a position of the control on the first display window, a size of the control on the first display window, and usage frequency of the control on the first display window.

In an embodiment, the target control which needs to be hidden may be determined by detecting a position of the control on the first display window. For example, the position of the target control relative to X and Y axes can be obtained by getX( ) and getY( ) functions. For example, when a size of the flexible display screen is expressed in pixels, a control adjacent to an edge of an interface window of the first display window within a certain pixel threshold may be hidden by comparing a size of the first display area with a size of the second display area. As illustrated in FIG. 4, the size of the first display window equals 1200*900 pixels, where an area adjacent to the edge below the interface window within 300 pixels includes three controls. It is assumed that the pixel threshold is set to 300 pixels. Then, before folding the flexible display screen, it is determined that a control adjacent to the edge of the interface window is the target control. The target control may be hidden when the flexible display is folded. At this time, the property of the target control is set to be invisible. When the target control which needs to be hidden is selected according to the position of the control, a display interface of the flexible display screen can also be represented by length. For example, a size of the display interface is 15*10 cm. A control adjacent to a boundary of the interface window within 1 cm is taken as the target control to hide.

In another embodiment, a size of the control on the first display window is determined, and a control which needs to be removed is determined according to the size of the control on the first display window, then changing a property of the control to be invisible, thus hiding the corresponding control on the second display window. The size of the control on the first display window herein includes a size of a pixel of the control, a size of an area of the control, a size of a storage space occupied by the control, and the like.

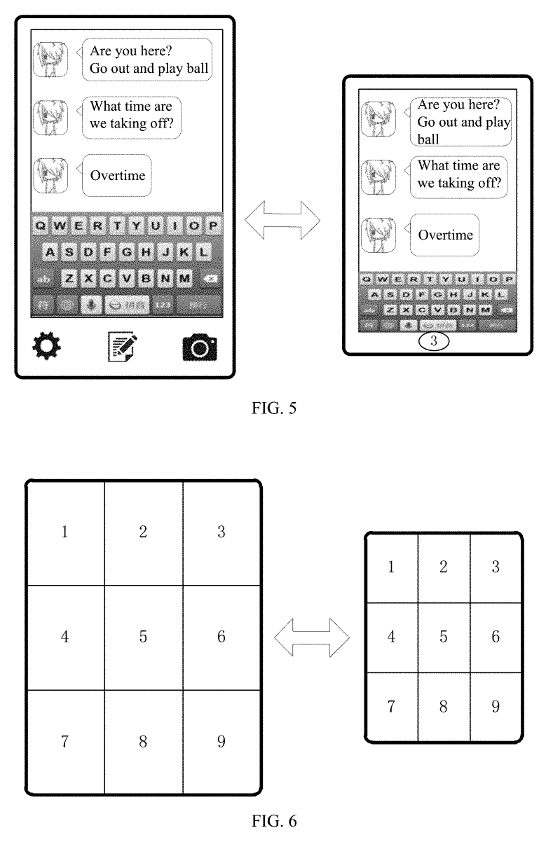

For example, In an embodiment, when the size of the control is calculated in pixels, as illustrated in FIG. 5, the first display window includes a chat window with a size of 1000*800 pixels, an input method window with a size of 400*800 pixels, and a set button, a memo button, and a camera button all with a size of 100*100 pixels. It is assumed that a preset condition is set to hide a control below a size of 200*200 pixels, then the target control in the display window are the set button, the memo button, and the camera button.

In another embodiment, since the area of the display area of the flexible display screen is reduced upon being folded, some larger controls cannot be displayed on the interface when the area of the display area is less than a certain value. The preset condition may also be set to hide a control, which is a target control, of which the area is larger than a certain threshold. Different conditions are set and different contents are displayed according to the specific display area of the flexible display screen, thus providing a better view effect for the user.

In another embodiment, a control which occupies a storage space greater than a certain threshold may be hidden, thus reducing a size of a memory occupied by the control when loading the interface.

In another embodiment, usage frequency of the control on first display window is obtained. A control of which the usage frequency is lower than a set threshold is taken as a target control, and a property of the target control is changed to be invisible, thus the target control can be hidden on the second display window. For example, the first display window of the flexible display screen includes five controls, such as a clock control, a weather control, a call function control, a short message control, and a setting button control. The frequency obtained by a system for the user to click the five controls is: clicking the clock control twice in one day, clicking the weather control once in one day, clicking the call function control 4 times in one day, clicking the short message control 5 times in one day, and clicking the set button control 2 times in one day. It is assumed that the usage frequency threshold preset by the system is set to be 3 times, and a control with usage frequency less than 3 times in one day is determined as the target control. When the first display area is switched to the second display area, the clock control, the weather control, and the set button control are taken as the target control to hide.

At block S106, prompt information containing the first parameter of the target control is displayed on the second display window.

In the embodiment, after obtaining the target control, a position of the target control on the first display window needs to be obtained. A corresponding target area of the second display window is obtained according to the position of the target control on the first display window. The prompt information containing the first parameter of the target control is displayed on the target area of the second display window corresponding to the position of the target control on the first display window.

In an embodiment, when the target control is determined according to the position of the control on the first display window at block S104, in this process at block S106, the target area on the second display window can be directly obtained according to the previously obtained position of the target control on the first display window.

In another embodiment, when the target control is determined according to the size or the usage frequency of the control at block S104, in this process at block S106, the position of the target control on the first display window is obtained firstly according to the property of the target control, thus determining the target area of the target control on the second display window. For example, the position of the target control relative to the X axes and Y axes can be obtained by the getX( ) function and the getY( ).

Still taking FIG. 4 and FIG. 5 as an example, when the obtained position of the target control on the first display window is located below the display window, then the position of the target control on the first display window corresponding to the target area of the second display window may be an edge of a lower side of the second display window. Such that the prompt information of the hidden control may be displayed on the lower side of the second display window.

In another embodiment, a determination of the target area of the target control on the second display window may have other conditions. For example, the first display area and the second display area are divided into a plurality of grids according to a manner illustrated in FIG. 6. Number of grids of the first display area equals number of grids of the second display. It is assumed that the first display area and the second display area include 3*3 areas, and the grids of the first display area and the grids of the second display area are sequentially numbered, respectively. When the flexible display screen is switched from the first display window to the second display window, the prompt information of the target control located at the grid 1 of the first display window may be prompted at a corresponding position of the grid 1 of the second display window according to a one-to-one correspondence between the grids of the first display area and the grids of the second display area. The other numbers of the grids may be deduced by analogy.

The prompt information of the target control located at each row/column of the grid of the first display window may be prompted at a middle position of the corresponding grid of the second display window. For example, the number of the target control located at the grids 1, 2, and 3 of the first display window is prompted at the grid 2 of the second display window. In practice, only some examples are listed herein. In actual situation, a correspondence between the grids can also be defined according to a certain algorithm, which will not be described in further details.

In an embodiment, the prompt information of the first parameter of the target control may be displayed on the second display window by a preset prompt icon, such as a size, a color, a dynamic display effect of the icon, thus providing a richer visual experience for the user.

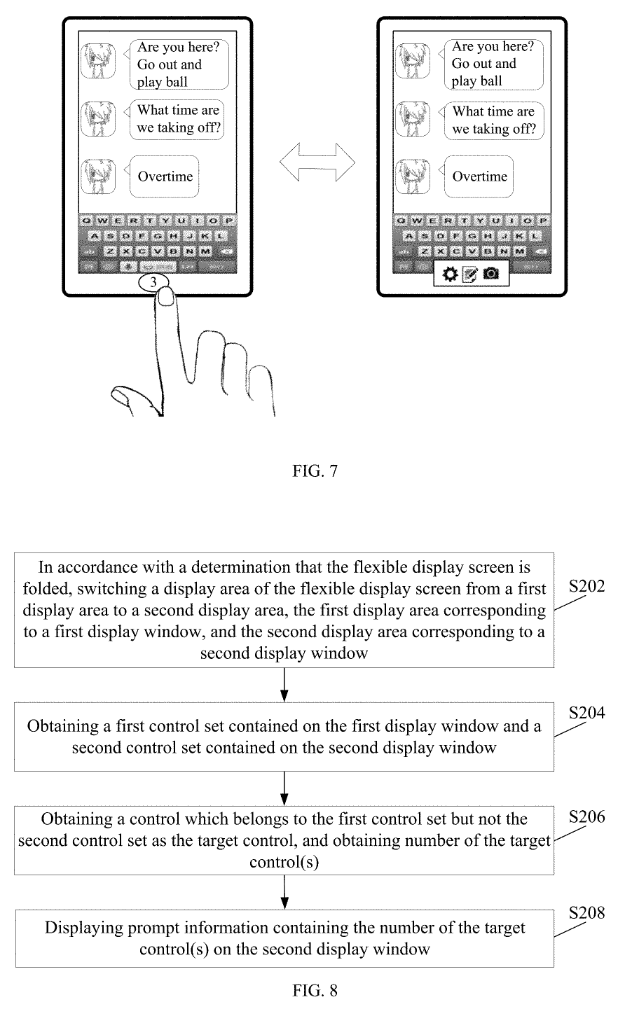

In an embodiment, in accordance with a determination that a click operation of the prompt information is detected, the target control is displayed on an adjacent area of the prompt icon. For example, as illustrated in FIG. 7, number of the control(s), which is(are) hidden on the second display window, is three, and prompt information at a bottom of the interface is three. When a prompt icon is clicked by a user, zoom-out icons of the setting button, the memo button, and the camera button are suspended on the interface, thus showing the user which functions are specifically hidden, and obtaining a more intuitive and convenient experience when the user is using them.

In an embodiment, when the first display window is switched to the second display window, and both of the first display window and the second display window include a hidden control. For example, number of control(s) displayed on the first display window is four, which are a call control, an address book control, a short message control, and a setting control, and number of control(s) hidden on the first display window is one, which is a clock control. When the first display window is switched to the second display window, number of control(s) displayed on the second display window is three, which are the call control, the address book control, and the short message control, and number of control(s) hidden on the second display window is two, which are the setting control and the clock control. Then, at this time, it is necessary to compare the control(s) hidden in the first display window with the control(s) hidden in the second display window, and number of the hidden control(s), which belong(s) to the second display window but not the first display window, is displayed on the second display window. That is, before switching the first display window to the second display window, a property of the control should be changed to invisible, and the number of the hidden control(s) displayed on the second display window is one. When the user clicks the prompt icon of the hidden control, the set control should be displayed.

In another embodiment, when the second display window is switched to the first display window, and both of the first display window and the second display window contain a hidden control. For example, number of control(s) displayed on the second display window is three, which are the call control, the address book control, and the short message control, and number of control(s) hidden on the second display window is two, which are the setting control and the clock control. When the second display window is switched to the first display window, number of control(s) displayed on the first display window is four, which are the call control, the address book control, the short message control and the setting control, and number of control(s) hidden on the first display window is one, which is the clock control. Then, before switching the second display window to the first display window, a property of the control should be changed to visible, and an icon corresponding to the control is displayed on the first display window. Such that for the clock control, which is hidden already on the first display window, the property of the clock control may be changed according to a user setting or a system function requirement, which will not be limited in the embodiment of the present disclosure.

### Embodiment 2

As illustrated in FIG. 8, FIG. 8 is a flowchart of an interaction method for a flexible display screen provided by another embodiment, and the method includes the following processes.

At block S202, in accordance with a determination that the flexible display screen is folded, a display area of the flexible display screen is switched from a first display area to a second display area. The first display area corresponds to a first display window, and the second display area corresponds to a second display window.

In this embodiment, in accordance with a determination that the flexible display screen is folded, the display area of the flexible display screen is switched from the first display area to the second display area. The first display area is a display area of the flexible display screen upon being unfolded, and the second display area is a display area of the flexible display screen upon being folded. A display window displayed on the first display area is defined as the first display window. A display window displayed on the second display area is defined as the second display window. Different contents can be displayed on the different display windows according to a size of the display area of the flexible display screen.

For example, as illustrated in a right figure of FIG. 1, the display area displayed on the flexible display screen in an unfolded state is the first display area. As illustrated in a left figure of FIG. 1, the display area displayed on the flexible display screen in a folded state is the second display area. The user can switch the display area of the flexible display screen upon folding or unfolding the flexible display to change the size of the display area of the flexible display screen.

At block S204, a first control set contained on the first display window and a second control set contained on the second display window are obtained.

In this embodiment, a control is a graphical user interface element, which is a basic visual building block. The control is contained in an application program, which is configured to control data processed by the application, and the interactive operation between the data and the user. The control includes a command control, such as a button, a selection control, such as a selection box, a drop-down menu, and a combination button, and an input control, such as a input box, a slider, and a search box, and a display control, such as a text box and a card. For example, when an interface window displayed by a current device is a music player, an interface control of the interface window includes, but is not limited to, a playlist control, a lyric display control, a song search control, and the like. When a song search function is selected, the interface control in the interface window can be a text box, a button, an information bar, and the like.

In this embodiment, control information respectively contained on the first display window and the second display window is pre-stored in a system. A control contained on a corresponding interface may be searched from a pre-stored file of the system according to the information, such as a title name of different display interfaces. All searched controls contained on the first display window are taken as the first control set, and all searched controls contained on the second display window are taken as the second control set.

In another embodiment, when the display interface of the flexible display screen is monitored to be loaded, a control on the display interface may be obtained. For example, when the first display window is monitored to be loaded, a control contained on the first display window is taken as the first control set. When the second display window is monitored to be loaded, a control contained on the second display window is taken as the second control set.

At block S206, a control which belongs to the first control set but not the second control set is obtained as the target control, and number of the target control(s) is obtained.

A control of the first control set is compared with a control of the second control set, and a control which belongs to the first control set but not the second control set is taken as the target control. Number of the target control(s) is obtained.

In this embodiment, a comparison can be based on control identifiers. Control identifiers of controls of the first control set and control identifiers of controls of the second control set are obtained, the control identifiers of the first control set is compared with the control identifiers of the second control set. The control which belongs to the first control set but not the second control set is obtained as the target control. For example, still taking FIG. 4 as an example, twelve controls contained on the first display window includes nine icons, a setting button labeled “setting”, a memo button labeled “memo”, and a camera button labeled “camera”. That is, the first control set includes twelve controls. Nine icons, that are nine controls, are contained on the first display window, then the second control set includes nine controls. The control which belongs to the first control set but not the second control set includes three controls, which are the setting button, the memo button, and the camera button, by comparing the first control set with the second control set. The three controls are taken as the target control, and the number of the target controls is three, which is prompted on the second display window.

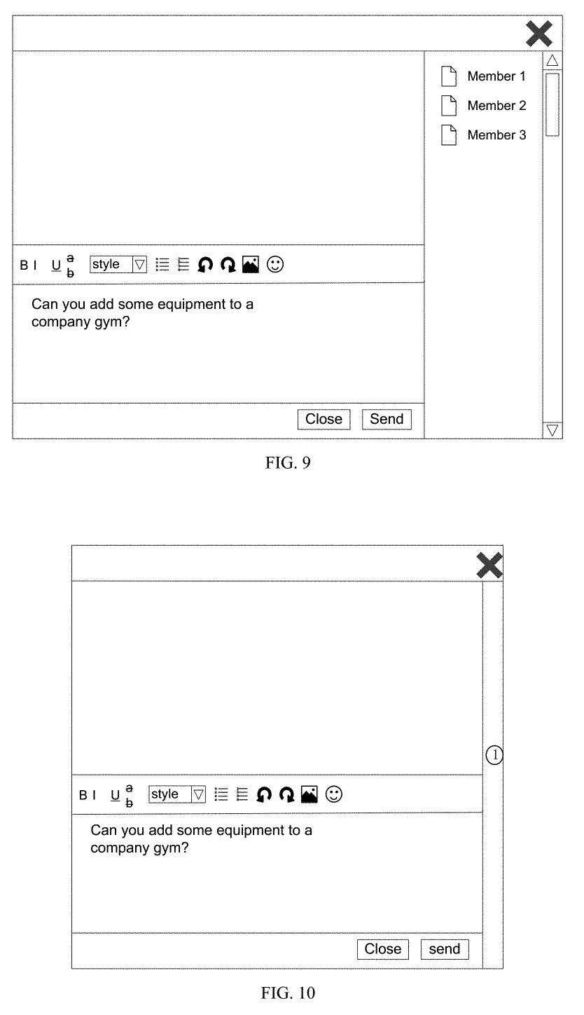

For another example, referring to FIG. 9, FIG. 9 is a schematic view of the first display window in an embodiment. It is assumed that an identifier of the first display window is “chat 1”, which mainly includes a chat interface, an input box, and a member list. At this time, when the flexible display screen is folded, the second display window displayed on the display area of the flexible display screen illustrated in FIG. 10 is identified as “chat 2”, which mainly includes a chat interface and an input box. The number of the control contained on the first display window, which is searched from the system according to the identifier of the control of the first control set, is three. That is, the first control set includes three controls, which are the chat interface, the input box, and the member list. The second control set includes two controls, which are the chat interface and the input box, and the chat interface and the input box are contained in the first control set. Therefore, the target control is the member list, and the number of the target control is one.

In this embodiment, before switching the display area of the flexible display screen from the first display area to the second display area, a relevant parameter of the control on the first display window is obtained. A control which needs to be removed according to the relevant parameter of the control on the first display window is determined as the target control. When the first display window is switched to the second display window, the target control is removed from the second display window. The related parameter of the control on the first display window includes a position, a size, usage frequency, and the like of the control on the first display window.

In an embodiment, the target control which needs to be removed may be determined by detecting a position of the control on the first display window. For example, the position of the target control relative to X and Y axes can be obtained by getX( ) and getY( ) functions. For example, when a size of the flexible display screen is expressed in pixels, a control adjacent to an edge of an interface window of the first display window within a certain pixel threshold may be removed by comparing a size of the first display area with a size of the second display area.

As illustrated in FIG. 4, the size of the first display window equals 1200*900 pixels, where an area adjacent to the edge below the interface window within 300 pixels includes three controls. It is assumed that the pixel threshold is set to 300 pixels. Then, before folding the flexible display screen, it is determined that a control adjacent to the edge of the interface window is the target control. The target control may be removed when the flexible display is folded. At this time, the property of the target control is set to be invisible. When the target control which needs to be removed is selected according to the position of the control, a display interface of the flexible display screen can also be represented by length. For example, a size of the display interface is 15*10 cm. A control adjacent to a boundary of the interface window within 1 cm is taken as the target control to remove.

In another embodiment, a size of the control on the first display window is determined, and a control which needs to be removed is determined according to the size of the control on the first display window, then changing a property of the control to be invisible, thus removing the corresponding control on the second display window. The size of the control on the first display window herein includes a size of a pixel of the control, a size of an area of the control, a size of a storage space occupied by the control, and the like.

For example, In an embodiment, when the size of the control is calculated in pixels, as illustrated in FIG. 5, the first display window includes a chat window with a size of 1000*800 pixels, an input method window with a size of 400*800 pixels, and a set button, a memo button, and a camera button all with a size of 100*100 pixels. It is assumed that a preset condition is set to remove a control below a size of 200*200 pixels, then the target control in the display window is the set button, the memo button, and the camera button.

In another embodiment, since the area of the display area of the flexible display screen is reduced upon being folded, some controls with a larger area cannot be displayed on the interface when the area of the display area is less than a certain value. The preset condition may also be set to remove a control, which is a target control, of which the area is larger than a certain threshold. Different conditions are set and different contents are displayed according to the specific display area of the flexible display screen, thus providing a better view effect for the user.

In another embodiment, a control which occupies a storage space greater than a certain threshold may be removed, thus reducing a size of a memory occupied by the control when loading the interface.

In another embodiment, usage frequency of the control on first display window is obtained. A control of which the usage frequency is lower than a set threshold is taken as a target control. For example, the first display window of the flexible display screen includes five controls, such as a clock control, a weather control, a call function control, a short message control, and a setting button control. The frequency obtained by a system for the user to click the five controls is: clicking the clock control twice in one day, clicking the weather control once in one day, clicking the call function control 4 times in one day, clicking the short message control 5 times in one day, and clicking the set button control 2 times in one day. It is assumed that the usage frequency threshold preset by the system is set to be 3 times, and a control with usage frequency less than 3 times in one day is determined as the target control. When the first display area is switched to the second display area, the clock control, the weather control, and the set button control are taken as the target control to remove.

It should be noted that, in this embodiment, the removal of the control is implemented by releasing a storage space of the corresponding control in a memory and clearing the saved control information.

At block S208, prompt information containing the number of the target control(s) is displayed on the second display window.

In the embodiment, after obtaining the target control, a position of the target control on the first display window needs to be obtained. A corresponding target area of the second display window is obtained according to the position of the target control on the first display window. The prompt information containing the number of the target control(s) is displayed on the target area of the second display window corresponding to the position of the target control on the first display window.

In an embodiment, when the target control is determined according to the position of the control on the first display window at block S204, in this process at block S206, the target area on the second display window can be directly obtained according to the previously obtained position of the target control on the first display window.

In another embodiment, when the target control is determined according to the size or the usage frequency of the control at block S204, in this process at block S206, the position of the target control on the first display window is obtained firstly according to the property of the target control, thus determining the target area of the target control on the second display window. For example, the position of the target control relative to the X axes and Y axes can be obtained by the getX( ) function and the getY( ).

Still taking FIG. 4 and FIG. 5 as an example, when the obtained position of the target control on the first display window is located below the display window, then the position of the target control on the first display window corresponding to the target area of the second display window may be an edge of a lower side of the second display window. Such that the prompt information of the hidden control may be displayed on the lower side of the second display window.

In another embodiment, a determination of the target area of the target control on the second display window may have other conditions. For example, the first display area and the second display area are divided into a plurality of grids according to a manner illustrated in FIG. 6. Number of grids of the first display area equals number of grids of the second display. It is assumed that the first display area and the second display area include 3*3 areas, and the grids of the first display area and the grids of the second display area are sequentially numbered, respectively. When the flexible display screen is switched from the first display window to the second display window, the prompt information of the target control located at the grid 1 of the first display window may be prompted at a corresponding position of the grid 1 of the second display window according to a one-to-one correspondence between the grids of the first display area and the grids of the second display area. The other numbers of the grids may be deduced by analogy.

The prompt information of the target control located at each row/column of the grid of the first display window may be prompted at a middle position of the corresponding grid of the second display window. For example, the number of the target control located at the grids 1, 2, and 3 of the first display window is prompted at the grid 2 of the second display window. In practice, only some examples are listed herein. In actual situation, a correspondence between the grids can also be defined according to a certain algorithm, which will not be described in further details.

In an embodiment, the prompt information of the first parameter of the target control may be displayed on the second display window by a preset prompt icon, such as a size, a color, a dynamic display effect of the icon, thus providing a richer visual experience for the user.

In an embodiment, in accordance with a determination that a click operation of the prompt information is detected, the target control is reloaded, and the target control is displayed on an adjacent area of the prompt icon. For example, as illustrated in FIG. 7, number of the control(s), which is(are) removed on the second display window, is three, and the prompt information at a bottom of the interface is three. When the prompt icon is clicked by a user, zoom-out icons of the setting button, the memo button, and the camera button are suspended on the interface, thus showing the user which functions are specifically removed, and obtaining a more intuitive and convenient experience when the user is using them.

It should be noted that, reloading the target control is implemented by writing a corresponding content of the control in the memory.

In another embodiment, when the second display window is switched to the first display window, the previously removed control can be reloaded on the first display window by the system, thus redisplaying the target control. For example, number of control(s) displayed on the second display window is three, which are the call control, the address book control, and the short message control, and number of control(s) removed from the second display window previously is two, which are the setting control and the clock control. When the second display window is switched to the first display window, the setting control and the clock control are reloaded, and correspond icons of the setting control and the clock control are displayed on the first display window.

It should be noted that, the interaction methods of the flexible display screens of the above two embodiments respectively correspond to different hidden manners. In the first embodiment, a state of the control is set as hidden or not hidden before and after switching to a corresponding window object. While the control itself still belongs to the window object, which is stored in a memory stack corresponding to the window object. In the second embodiment, a state of the control is set as remove or reloading before and after switching to the corresponding window object. That is, the corresponding target control does not exist in the memory stack corresponding to the window object. Therefore, the interaction methods of the flexible display screens of the above two embodiments respectively correspond to different hidden manners of the control on different display windows.

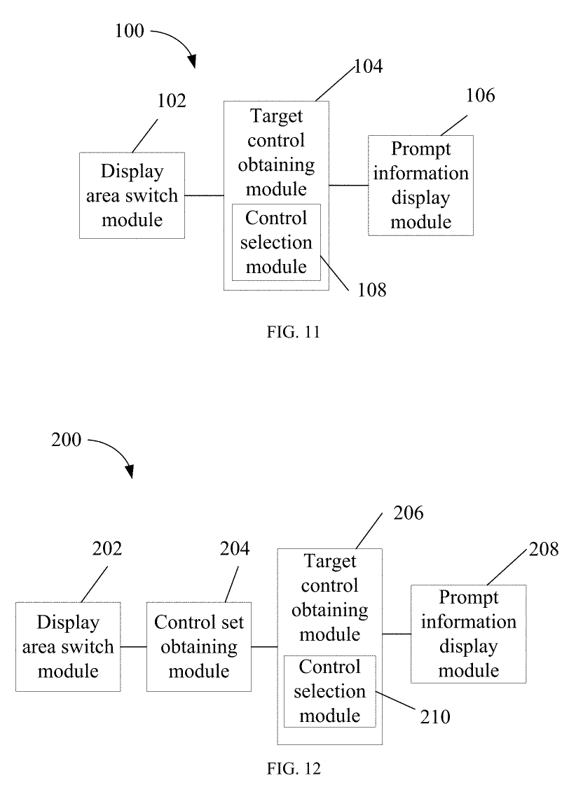

Furthermore, in order to solve a technical problem in the prior art that, when a user operates on a small screen interface, the user can't know whether there are more controls on the same application interface in a large screen state, such that operable functions may be insufficient for the user, and the user experience may be decreased. An interaction device 100 for a flexible display screen is provided. As illustrated in FIG. 11, the interaction device 100 for a flexible display screen includes a display area switch module 102, a target control obtaining module 104, a prompt information display module 106, and a control selection module 108.

The display area switch module 102 is configured to, in accordance with a determination that the flexible display screen is folded, switch a display area of the flexible display screen from a first display area to a second display area. The first display area corresponds to a first display window, and the second display area corresponds to a second display window.

The target control obtaining module 104 is configured to obtain a control on the second display window with a property of invisibility as a target control, and obtain a first parameter of the target control.

The prompt information display module 106 is configured to display prompt information containing the first parameter of the target control on the second display window.

Alternatively, the target control obtaining module 104 includes the control selection module 108 configured to:
before switching the display area of the flexible display screen from the first display area to the second display area, determine a control which needs to be hidden according to a relevant parameter of a control on the first display window as the target control; where the related parameter of the control includes at least one of a position of the control on the first display window, a size of the control on the first display window, and usage frequency of the control on the first display window; change the property of the control, which needs to be hidden, to be invisible.

Alternatively, the target control obtaining module 104 is further configured to:
obtain feature information of the target control, and generate the first parameter by doing statistical analysis of the feature information of the target control. The first parameter includes at least one of quantity, title, format, and position of the target control.

Alternatively, the prompt information display module 106 is further configured to:
obtain a position of the target control of the control on the first display window, and obtain a target area of the second display window corresponding to the position of the target control on the first display window; and
display the prompt information containing the first parameter of the target control on the target area of the second display window corresponding to the position of the target control on the first display window.

Alternatively, the prompt information display module 106 is further configured to:
display the prompt information of the first parameter of the target control by a preset prompt icon; and
in accordance with a determination that a clicking operation is detected on the prompt icon, display the target control on an adjacent area of the prompt icon.

Furthermore, in order to solve a technical problem in the prior art that, when a user operates on a small screen interface, the user can't know whether there are more controls on the same application interface in a large screen state, such that operable functions may be insufficient for the user, and the user experience may be decreased. An interaction device 200 for a flexible display screen is further provided. As illustrated in FIG. 12, the interaction device 200 for a flexible display screen includes a display area switch module 202, a control set obtaining module 204, a target control obtaining module 206, a prompt information display module 208, and a control selection module 210.

The display area switch module 202 is configured to, in accordance with a determination that the flexible display screen is folded, switch the display area of the flexible display screen from the first display area to the second display area. The first display area corresponds to a first display window, and the second display area corresponds to a second display window.

The control set obtaining module 204 is configured to obtain a first control set contained on the first display window and a second control set contained on the second display window.

The target control obtaining module 206 is configured to obtain a control which belongs to the first control set but not the second control set as the target control, and obtain number of the target control(s).

The prompt information display module 208 is configured to display prompt information containing the number of the target control(s) on the second display window.

Alternatively, the target control obtaining module 206 includes the control selection module 210 configured to:
before switching the display area of the flexible display screen from the first display area to the second display area, determine a control, which needs to be removed, according to a relevant parameter of a control on the first display window as the target control; where the related parameter of the control includes at least one of a position of the control on the first display window, a size of the control on the first display window, and usage frequency of the control on the first display window; and
remove the control, which needs to be removed, from the second display window.

Alternatively, the target control obtaining module 206 is further configured to:
obtain a control identifier of a control of the first control set and a control identifier of a control of the second control set, compare the control on the first control set with the control on the second control set according to the control identifier of the control of the first control set and the control identifier of the control of the second control set;
and obtain the control which belongs to the first control set but not the second control set as the target control; and
obtain feature information of the target control, and generate the number of the target control(s) by doing statistical analysis of the feature information of the target control.

Alternatively, the prompt information display module 208 is further configured to:
obtain a position of the target control of the control on the first display window, and obtain a target area of the second display window corresponding to a position of the target control on the first display window; and
display the prompt information containing the number of the target control(s) on the target area of the second display window corresponding to the position of the target control on the first display window.

Alternatively, the prompt information display module 208 is further configured to:
display the prompt information of the number of the target control by a preset prompt icon; and
in accordance with a determination that a clicking operation is detected on the prompt icon, reload the target control, and display the target control on an adjacent area of the prompt icon.

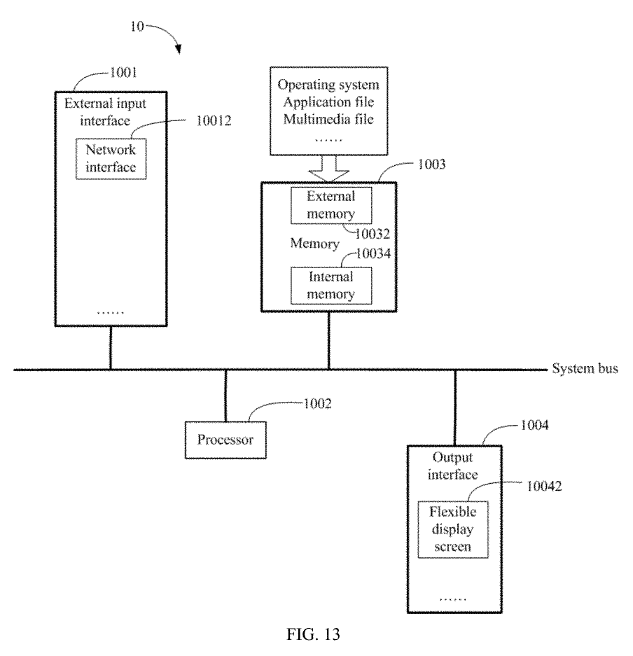

In the embodiment, as illustrated in FIG. 13, FIG. 13 illustrates a terminal device of a computer system 10 based on a von Neumann Computer system which operates the above interaction method for a flexible display screen. The computer system 10 can be a terminal device, such as a smart phone, a tablet, a palmtop, a laptop, or a personal computer. Specifically, the terminal device of the computer system 10 may include an external input interface 1001, a processor 1002, a memory 1003, and an output interface 1004, which are connected with each other by a system bus. Alternatively, the external input interface 1001 may at least include a network interface 10012. The memory 1003 may include an external memory 10032 (such as, a hard disk, an optical disk, or a floppy disk) and an internal memory 10034. The output interface 1004 may at least include a flexible display screen 10042.

In this embodiment, the method is run based on the computer program. Program files of the computer program are stored in the external memory 10032 of the above computer system 10 based on a von Neumann Computer system, which are loaded into the internal memory 10034 at runtime, compiled into a machine code, and then transmitted to the processor 1002 for processing, thus forming the display area switch module 102, target control obtaining module 104, prompt information display module 106, and control selection module 108 in the computer system 10 based on the von Neumann Computer system. In the implementation of the interaction method for a flexible display screen, input parameters are all received by the external input interface 1001 and transmitted to the memory 1003 for caching, and then input to the processor 1002 for processing. The processed result data is cached in the memory 1003 for subsequent processing, or transmitted to the output interface 1004 for output.

Specifically, the processor 1002 is configured to perform the following processes.

In accordance with a determination that the flexible display screen is folded, a display area of the flexible display screen is switched from a first display area to a second display area, where the first display area corresponds to a first display window, and the second display area corresponds to a second display window.

A control on the second display window with a property of invisibility as a target control is obtained, and a first parameter of the target control is obtained.

Prompt information containing the first parameter of the target control is displayed on the second display window.

Alternatively, the interaction method further includes: before switching the display area of the flexible display screen from the first display area to the second display area, determining a control which needs to be hidden according to a relevant parameter of a control on the first display window as the target control. The related parameter of the control includes at least one of a position of the control on the first display window, a size of the control on the first display window, and usage frequency of the control on the first display window.

Switching the display area of the flexible display screen from the first display area to the second display area further includes: changing the property of the control, which needs to be hidden, to be invisible.

Alternatively, obtaining the first parameter of the target control includes: obtaining feature information of the target control, and generating the first parameter by doing statistical analysis of the feature information of the target control. The first parameter includes at least one of quantity, title, format, and position of the target control.

Alternatively, the interaction method further includes: after obtaining the control on the second display window with the property of invisibility as the target control:
obtaining a target area of the second display window corresponding to a position of the target control on the first display window according to the position of the target control of the control on the first display window;
displaying the prompt information containing the first parameter of the target control on the target area of the second display window corresponding to the position of the target control on the first display window.

Alternatively, displaying the prompt information containing the first parameter of the target control on the second display window includes: displaying the prompt information of the first parameter of the target control by a preset prompt icon.

The interaction method further includes:
in accordance with a determination that a clicking operation is detected on the prompt icon, displaying the target control on an adjacent area of the prompt icon.

In this embodiment, the method is run based on the computer program. Program files of the computer program are stored in the external memory 10032 of the above computer system 10 based on a von Neumann Computer system, which are loaded into the internal memory 10034 at runtime, compiled into a machine code, and then transmitted to the processor 1002 for processing, thus forming the display area switch module 202, control set obtaining module 204, target control obtaining module 206, prompt information display module 208, and control selection module 210 in the computer system 10 based on the von Neumann Computer system. In the implementation of the interaction method for a flexible display screen, input parameters are all received by the external input interface 1001 and transmitted to the memory 1003 for caching, and then input to the processor 1002 for processing. The processed result data is cached in the memory 1003 for subsequent processing, or transmitted to the output interface 1004 for output.

Specifically, the processor 1002 is configured to perform the following processes.

In accordance with a determination that the flexible display screen is folded, a display area of the flexible display screen is switched from a first display area to a second display area, where the first display area corresponds to a first display window, and the second display area corresponds to a second display window.

A first control set contained on the first display window and a second control set contained on the second display window are obtained.

A control which belongs to the first control set but not the second control set as the target control, and obtaining number of the target control(s) is obtained.

Prompt information containing the number of the target control(s) is displayed on the second display window.

Alternatively, the interaction method further includes: before switching the display area of the flexible display screen from the first display area to the second display area, determining a control, which needs to be removed, according to a relevant parameter of a control on the first display window as the target control. The related parameter of the control includes at least one of a position of the control on the first display window, a size of the control on the first display window, and usage frequency of the control on the first display window.

Switching the display area of the flexible display screen from the first display area to the second display area further includes:

removing the control, which needs to be removed, from the second display window.

Alternatively, obtaining the control which belongs to the first control set but not the second control set as the target control, and obtaining the number of the target control(s) includes:
obtaining a control identifier of a control of the first control set and a control identifier of a control of the second control set, comparing the control on the first control set with the control on the second control set according to the control identifier of the control of the first control set and the control identifier of the control of the second control set; and obtaining the control which belongs to the first control set but not the second control set as the target control; and
obtaining feature information of the target control, and generating the number of the target control(s) by doing statistical analysis of the feature information of the target control.

Alternatively, the interaction method further includes:
after obtaining the control which belongs to the first control set but not the second control set as the target control:
obtaining a target area of the second display window corresponding to a position of the target control on the first display window according to the position of the target control of the control on the first display window; and
displaying the prompt information containing the number of the target control(s) on the target area of the second display window corresponding to the position of the target control on the first display window.

Alternatively, displaying the prompt information containing the first parameter of the target control on the second display window includes:
displaying the prompt information of the number of the target control by a preset prompt icon.

The interaction method further includes:
in accordance with a determination that a clicking operation is detected on the prompt icon, reloading the target control, and displaying the target control on an adjacent area of the prompt icon.

It will be understood by those of ordinary skill in the art that all or a part of the various methods of the embodiments described above may be accomplished by means of a program to instruct associated hardware, the program may be stored in a computer-readable memory, which may include a flash memory, a read-only memory (ROM), a random-access memory (RAM), Disk or compact disc (CD), and so on.

The above is only the preferable embodiment of the present disclosure, the scope of the present disclosure is not limited to thereof. It will be understood by those of ordinary skill in the art that all or a part of the process of the method of the above embodiments described above, and equivalent changes made in the claims of the present disclosure are still within the scope of the present disclosure.

What is claimed is:

1. An interaction method for a flexible display screen, comprising:
in accordance with a determination that the flexible display screen is folded, switching a display area of the flexible display screen from a first display area to a second display area, the first display area corresponding to a first display window, and the second display area corresponding to a second display window;
obtaining a control on the second display window with a property of invisibility as a target control, and obtaining a first parameter of the target control; and
displaying prompt information containing the first parameter of the target control on the second display window.

2. The interaction method of claim 1, further comprising:
before switching the display area of the flexible display screen from the first display area to the second display area, determining a control which needs to be hidden according to a relevant parameter of a control on the first display window as the target control; the related parameter of the control comprises at least one of a position of the control on the first display window, a size of the control on the first display window, and usage frequency of the control on the first display window;
switching the display area of the flexible display screen from the first display area to the second display area further comprises:
changing the property of the control, which needs to be hidden, to be invisible.

3. The interaction method of claim 1, wherein obtaining the first parameter of the target control comprises:
obtaining feature information of the target control, and generating the first parameter by doing statistical analysis of the feature information of the target control; the first parameter comprises at least one of quantity, title, format, and position of the target control.

4. The interaction method of claim 1, further comprising:
after obtaining the control on the second display window with the property of invisibility as the target control:
obtaining a target area of the second display window corresponding to a position of the target control on the first display window according to the position of the target control of the control on the first display window;
displaying the prompt information containing the first parameter of the target control on the target area of the second display window corresponding to the position of the target control on the first display window.

5. The interaction method of claim 1, wherein the displaying the prompt information containing the first parameter of the target control on the second display window further comprises:
displaying the prompt information of the first parameter of the target control by a preset prompt icon;
the interaction method further comprises:
in accordance with a determination that a clicking operation is detected on the prompt icon, displaying the target control on an adjacent area of the prompt icon.

6. An interaction method for a flexible display screen, comprising:
in accordance with a determination that the flexible display screen is folded, switching a display area of the flexible display screen from a first display area to a second display area, the first display area corresponding to a first display window, and the second display area corresponding to a second display window;
obtaining a first control set contained on the first display window and a second control set contained on the second display window;
obtaining a control which belongs to the first control set but not the second control set as the target control, and obtaining number of the target control(s); and
displaying prompt information containing the number of the target control(s) on the second display window.

7. The interaction method of claim 6, further comprising:
before switching the display area of the flexible display screen from the first display area to the second display area, determining a control, which needs to be removed, according to a relevant parameter of a control on the first display window as the target control; the related parameter of the control comprises at least one of a position of the control on the first display window, a size of the control on the first display window, and usage frequency of the control on the first display window;
switching the display area of the flexible display screen from the first display area to the second display area further comprises:
removing the control, which needs to be removed, from the second display window.

8. The interaction method of claim 6, wherein obtaining the control which belongs to the first control set but not the second control set as the target control, and obtaining the number of the target control(s) comprises:
obtaining a control identifier of a control of the first control set and a control identifier of a control of the second control set, comparing the control on the first control set with the control on the second control set according to the control identifier of the control of the first control set and the control identifier of the control of the second control set; and obtaining the control which belongs to the first control set but not the second control set as the target control;
obtaining feature information of the target control, and generating the number of the target control(s) by doing statistical analysis of the feature information of the target control.

9. The interaction method of claim 6, further comprising:
after obtaining the control which belongs to the first control set but not the second control set as the target control:
obtaining a target area of the second display window corresponding to a position of the target control on the first display window according to the position of the target control of the control on the first display window;
displaying the prompt information containing the number of the target control(s) on the target area of the second display window corresponding to the position of the target control on the first display window.

10. The interaction method of claim 6, wherein displaying the prompt information containing the first parameter of the target control on the second display window comprises:
displaying the prompt information of the number of the target control by a preset prompt icon;
the interaction method further comprises:
in accordance with a determination that a clicking operation is detected on the prompt icon, reloading the target control, and displaying the target control on an adjacent area of the prompt icon.

11. An interaction device for a flexible display screen, comprising:
a processor; and
a memory coupled to the processor and configured to store at least one computer program which, when executed by the processor, performs operations comprising:
in accordance with a determination that the flexible display screen is folded, switching a display area of the flexible display screen from a first display area to a second display area, the first display area corresponding to a first display window, and the second display area corresponding to a second display window;
obtaining a control on the second display window with a property of invisibility as a target control, and obtaining a first parameter of the target control; and
displaying prompt information containing the first parameter of the target control on the second display window.

12. The interaction device of claim 11, wherein the at least one computer program which, when executed by the processor, performs operations comprising:
before switching the display area of the flexible display screen from the first display area to the second display area, determining a control which needs to be hidden according to a relevant parameter of a control on the first display window as the target control; the related parameter of the control comprises at least one of a position of the control on the first display window, a size of the control on the first display window, and usage frequency of the control on the first display window; and
changing the property of the control, which needs to be hidden, to be invisible.

13. The interaction device of claim 11, wherein the at least one computer program which, when executed by the processor, performs operations such that obtaining the control on the second display window with the property of the invisibility as the target control, and obtaining the first parameter of the target control comprises:
obtaining feature information of the target control, and generating the first parameter by doing statistical analysis of the feature information of the target control;
the first parameter comprises at least one of quantity, title, format, and position of the target control.

14. The interaction device of claim 11, wherein the at least one computer program which, when executed by the processor, performs operations such that displaying the prompt information containing the first parameter of the target control on the second display window comprises:
after obtaining the control on the second display window with the property of invisibility as the target control:
obtaining a target area of the second display window corresponding to a position of the target control on the first display window according to the position of the target control of the control on the first display window; and
displaying the prompt information containing the first parameter of the target control on the target area of the second display window corresponding to the position of the target control on the first display window.

15. The interaction device of claim 11, wherein the at least one computer program which, when executed by the processor, performs operations such that displaying the prompt information containing the first parameter of the target control on the second display window comprises:
displaying the prompt information of the first parameter of the target control by a preset prompt icon; and
in accordance with a determination that a clicking operation is detected on the prompt icon, displaying the target control on an adjacent area of the prompt icon.

16. An interaction device for a flexible display screen, comprising:
a processor; and
a memory coupled to the processor and configured to store at least one computer program which, when executed by the processor, performs operations comprising:
in accordance with a determination that the flexible display screen is folded, switching a display area of the flexible display screen from a first display area to a second display area, the first display area corresponding to a first display window, and the second display area corresponding to a second display window;
obtaining a first control set contained on the first display window and a second control set contained on the second display window;
obtaining a control which belongs to the first control set but not the second control set as the target control, and obtaining number of the target control(s); and
displaying prompt information containing the number of the target control(s) on the second display window.

17. The interaction device of claim 16, wherein the at least one computer program which, when executed by the processor, performs operations comprising:
before switching the display area of the flexible display screen from the first display area to the second display area, determining a control, which needs to be removed, according to a relevant parameter of a control on the first display window as the target control; the related parameter of the control comprises at least one of a position of the control on the first display window, a size of the control on the first display window, and usage frequency of the control on the first display window; and
removing the control, which needs to be removed, from the second display window.

18. The interaction device of claim 16, wherein the at least one computer program which, when executed by the processor, performs operations such that obtaining the control which belongs to the first control set but not the second control set as the target control, and obtaining the number of the target control(s) comprises:
obtaining a control identifier of a control of the first control set and a control identifier of a control of the second control set, comparing the control on the first control set with the control on the second control set according to the control identifier of the control of the first control set and the control identifier of the control of the second control set; and obtaining the control which belongs to the first control set but not the second control set as the target control; and
obtaining feature information of the target control, and generating the number of the target control(s) by doing statistical analysis of the feature information of the target control.

19. The interaction device of claim 16, wherein the at least one computer program which, when executed by the processor, performs operations such that displaying the prompt information containing the number of the target control(s) on the second display window comprises:
after obtaining the control which belongs to the first control set but not the second control set as the target control:
obtaining a target area of the second display window corresponding to a position of the target control on the first display window according to the position of the target control of the control on the first display window; and
displaying the prompt information containing the number of the target control(s) on the target area of the second display window corresponding to the position of the target control on the first display window.

20. The interaction device of claim 16, wherein the at least one computer program which, when executed by the processor, performs operations such that displaying the prompt information containing the number of the target control(s) on the second display window comprises:
displaying the prompt information of the number of the target control by a preset prompt icon; and
in accordance with a determination that a clicking operation is detected on the prompt icon, reloading the target control, and displaying the target control on an adjacent area of the prompt icon.
